(19) United States
(12) Patent Application Publication
(10) Pub. No.: US 2004/0148490 A1
(43) Pub. Date: Jul. 29, 2004

(54) Multiple register load using a Very Long Instruction Word

(76) Inventors: Adrian John Anderson, Nr Chepstow (GB); Michael John Davis, Bath (GB)

Correspondence Address: FLYNN THIEL BOUTELL & TANIS, P.C., 2026 RAMBLING ROAD, KALAMAZOO, MI, 49008-1699, US

(21) Appl. No.: 10/397,966

(22) Filed: Mar. 26, 2003

(30) Foreign Application Priority Data
Jan. 27, 2003 (GB) GB 0301844.7

(51) Int. Cl. G06F 15/00

(52) U.S. Cl. 712/24

(57) ABSTRACT

A processor system is formed from a plurality of processor elements (6). A plurality of registers (8) are provided for use with the processing elements and an instruction decoder (4) is configured to decode a first portion of at least one Very Long Instruction Word (VLIW) as a multiple register load instruction. A second larger portion of the VLIW is decoded as data to enable loading of a plurality of individual ones of a plurality of registers.

### FIELD OF THE INVENTION

This invention relates to a multiple process or system with a multiple register load using a very long instruction word (VLIW) of the type used to address a plurality of independent processing elements, and in particular to multiple register loads which may be used with an array of processors which carry out a large number of operations in parallel.

### BACKGROUND TO THE INVENTION

In processor systems there are typically provided a plurality of independent processing elements, a register bank to store data values required by the processing elements to perform processes, a memory unit to insert data values from memory into the register bank, and an instruction decoder to provide operation codes to the processing elements. Such systems are addressed by what are known as Very Long Instruction Words (VLIW), typically in excess of 64-bits and divided up into a number of fields to control the independent processing elements. The VLIW is provided to an instruction decoder (or VLIW processor). The VLIW processor is usually based around what is known as a load/store architecture. In this, a limited number of the VLIW fields, are used to control the loading/storing of processor registers in the register bank via an address unit.

When setting up processing elements to process e.g. data vectors or matrices it is common practice to structure the code to perform these operations as a number of repeat loops. When this is done, it is frequently the case that most of the lines of code required to implement a repeat loop are used to initialise the processor state before loop execution begins. This involves loading various registers with data values. As only a limited number of the fields in the VLIW are used for loading/storing of processor registers, setting up the processor to perform this type of processing will require multiple instruction words, each specifying the loading of a small number of registers. This process will have to repeat several times if a larger number of registers is being used. Because of this, instruction memory is not used efficiently and a larger area of silicon is required for instruction memory to implement a given function. This is more expensive and can be a particular problem where size of memory is an important factor.

### SUMMARY OF THE INVENTION

Preferred embodiments of the present invention provide a processor system with an instruction decoder configured to decode a first portion of a very long instruction word (VLIW) as a multiple register load instruction and a second larger portion of a VLIW instruction word as data to enable loading of multiple registers in a register bank associated with the system.

Preferably the second larger part of the instruction comprises a plurality of single bit fields, one for each register addressed by that instruction to enable loading of that register.

Preferably the second larger portion of the instruction comprises a single bit field for every register in the system.

The invention is defined with more precision in the appended claims to which reference should now be made.

### BRIEF DESCRIPTION OF THE DRAWINGS

A preferred embodiment of the invention will now be, described in detail by way of example with reference to the accompanying figures in which:

FIG. 1 shows an example of a VLIW instruction word;

FIG. 2 shows in detail instruction field 1 of the VLIW instruction word of FIG. 1;

FIG. 3 shows an instruction word used in an embodiment of the invention; and

FIG. 4 shows a block diagram of a system embodying the invention.

### DETAILED DESCRIPTION OF PREFERRED EMBODIMENT

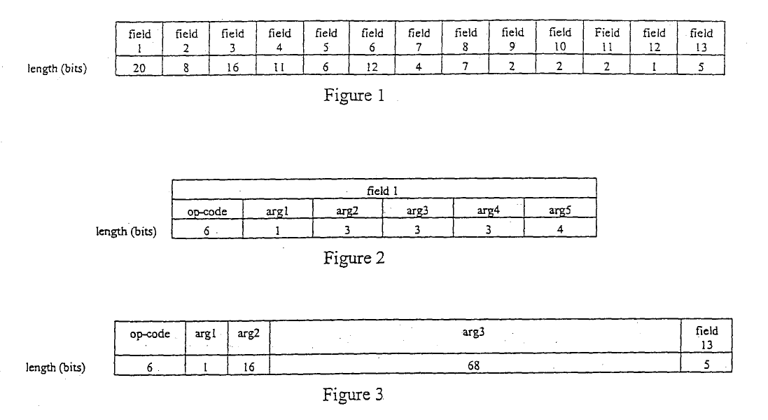

The VLIW instruction word shown in FIG. 1 comprises a total of 96-bits divided up into 13 unequal but fixed length instruction fields. Each field is used to control a single processing element. The functionality of the processing element is defined by a sub-set of the bits in the field, with the remaining bits being used to specify the source and destination registers for the data on which operations are to be performed. The first two fields, field 1 and field 2, are used to define load/store type operations required to initialise the registers use in a subsequent instruction to a processing element.

Instruction field 1 is shown in more detail in FIG. 2. This field is a total of 20-bits. The first 6 bits are an operation code (opcode). This is used to define the operation to be performed by the instruction decoder which will initially recognise this field as a load/store instruction. The remaining 14-bits of the instruction field are five separate values or arguments numbered arg1 to arg5. The opcode and the arguments fully define the operation of the processor element on one clock cycle and the registers to be used for source and destination of the data to be processed.

The format of an instruction used in a multiple register load in an embodiment of the invention is illustrated in FIG. 3. In this, FIGS. 1-12 of FIG. 1 are replaced by a 6-bit opcode and three arguments numbered arg1 to arg3. The opcode has a special meaning, not used in known processing systems, and is used to either specify a multiple load from an address supplied as an immediate argument or a multiple load from an address held in a register. arg1 is used to specify the format of the data in memory. This can be complex or double precision format. arg2 holds either a 16-bit immediate address in the case that the opcode specifies a load from an immediate address or the identity of an address register if the opcode specifies a load from an address held in a register.

arg3 is the register load mask. This comprises a field including a plurality of single bits each corresponding to a register that can be loaded. If the bit field contains a one then a load of the register associated with that position is enabled. If the field contains a zero then the load is disabled. In this particular example, the machine has 36 registers associated with the data processing elements and a further 31 associated with the addressing unit. Therefore, the size of arg3 is 67 bits. The size of the opcode and the arguments in this instruction are of course application specific. The system can be configured to decode instructions in accordance with the size of the processor element array and register bank which is to be loaded.

The memory which holds the values to be loaded into registers is preferably accessed linearly with a unity increment. An auto-increment for each register specified in the register load mask is implemented. Therefore, once the initial address has been accessed, the system cycles through successive addresses loading values into each register in turn.

Preferably, where some registers are not to be loaded, the auto-increment is disabled until a register load is reached. Therefore, if e.g. only 28 of the registers were to be loaded then 28 consecutive memory locations would be used for storage of the data to be loaded into them.

It will be appreciated that although specified in a single VLIW instruction the execution of the multiple register load will consume a number of machine execution cycles. An instruction decoder unit of the processor will handle the sequencing of this instruction to generate the multiple memory accesses required to satisfy the individual register loads as specified by the register load mask. In the example given in FIG. 3, field 13 is still available for control of its processor element although not all systems permit this. If the machine contains fewer registers then the register load mask will be shorter and more fields may be available to control other processor elements in parallel with a multiple load operation.

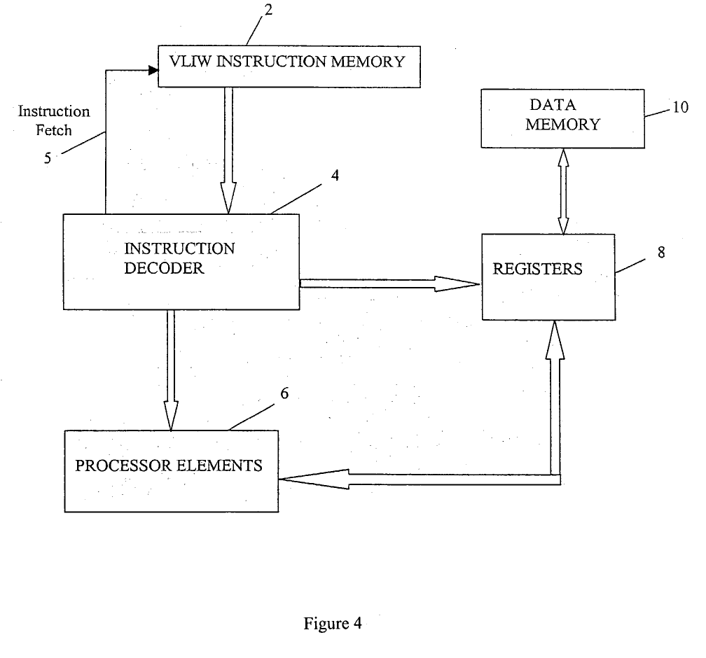

FIG. 4 shows a block diagram of a system in which this invention may be embodied. This comprises a VLIW instruction memory 2. This is coupled to an instruction decoder 4. The instruction decoder sends an instruction fetch signal 5 to the VLIW instruction memory 4 which provides a VLIW instruction to it. The instruction decoder is coupled to processor elements 6 to provide opcodes destined for those processor elements from the VLIW instruction words retrieved from VLIW instruction memory 2. It is also coupled to a bank of registers 8 which in turn ate coupled to a data memory 10 which stores values which may be loaded into the registers 8.

In normal operation, the instruction decoder 4 will cause processor elements 6 to execute opcodes received in a VLIW instruction having the format of FIG. 1, i.e. each one has a field of the type shown in FIG. 2 destined for it comprising an opcode and various arguments specifying the registers to be accessed.

When the instruction decoder 4 receives a multiple load instruction having the format of FIG. 3, it recognises the initial opcode as a multiple load opcode. The format of the data in memory is identified by arg1 and arg2 then specifies a 16-bit immediate address if the opcode specifies a load from the immediate address or the identity of an address register if the opcode specifies a load from an address held in the register.

If the instruction is to load from an immediate memory, data is loaded initially from the immediate address specified in data memory 10 into the first of the registers. Successive accesses then load values from successive addresses in the data memory 10 into the registers 8 in dependence on whether or not the respective bit for each register enables a load.

The opcode 6 may specify that each register should have the same value from data memory loaded into it or it may specify that successive memory locations be used.

1. A processor system comprising an array of processing elements, a plurality of registers for use with the processing elements and an instruction decoder configured to decode a first portion of at least one very long instruction word (VLIW) as a multiple register load instruction and a second larger portion of the VLIW as data to enable loading of a plurality of individual ones of the plurality of registers.

2. A processor system according to claim 1 in which the second larger part of the VLIW instruction comprises a plurality of single bits, one for each register addressed by that instruction enable loading of that register.

3. A processor system according to claim 2 in which there is a single bit for every register.

4. A processor system according to any previous claim in which the VLIW instruction includes a memory address for data to be loaded into registers.

5. A processor system according to claim 4 including means to address successive memory addresses and load data from the successive addresses into successively addressed registers.

6. A processor system according to claim 2 in which the single bits take a first value to enable loading of an associated register and a second value to disable loading of that register.

7. A method for loading data into a plurality of registers associated with an array of processing elements in a processor system comprising the steps of, identifying a first portion of a VLIW instruction as a multiple load instruction, identifying a second larger portion of a VLIW instruction as data to enable loading of the registers, and loading the registers in dependence on the data in the second part of the VLIW instruction.
